(19) United States
(12) Patent Application Publication
(10) Pub. No.: US 2015/0111504 A1
(43) Pub. Date: Apr. 23, 2015

(54) CALIBRATION COUPLEING UNIT, CCU, AND A METHOD THEREIN FOR ENABLING CALIBRATION OF BASE STATION

(71) Applicants: Chunhui Zhang, Taby (SE); Fredrik Huss, Sundbyberg (SE); Youping Su, Beijing (CN)

(72) Inventors: Chunhui Zhang, Taby (SE); Fredrik Huss, Sundbyberg (SE); Youping Su, Beijing (CN)

(73) Assignee: Optis Cellular Technology, LLC, Plano, TX (US)

(21) Appl. No.: 14/407,429

(22) PCT Filed: Jun. 12, 2012
(86) PCT No.: PCT/SE2012/050632

§ 371 Date: Dec. 11, 2014

(51) Int. Cl. H04W 24/02

(52) U.S. Cl. CPC H04W 24/02
USPC 455/67.11

(57) ABSTRACT

A Calibration Coupling Unit, CCU, and a method therein for enabling calibration of a Base Station are provided. The CCU comprises an Antenna Interface Standards Group, AISG, interface and the CCU is connected to the Base Station by means of radio branch feeder cables carrying uplink and downlink transmissions to/from the Base Station. The Base Station comprises a Radio Unit, RU, and a Base Band Unit, BBU, and the CCU is further connectable to an antenna array comprising antenna elements. The method in the CCU comprises receiving (110) at least one calibration signal from the RU on at least one radio branch feeder cable of the CCU; and converting (130) the calibration signal to a receiving frequency band of the RU. The method further comprises providing (140) the converted signal to the RU via at least one of the radio branch feeder cables, thereby enabling calibration of the Base Station.

### TECHNICAL FIELD

The present disclosure relates to calibration and in particular to a calibration coupling unit for enabling calibration of a base station.

### BACKGROUND

Multiple Input Multiple Output, MIMO, technology is widely used today for different communication networks as a means to achieve high throughput. Beamforming is one special case of the MIMO which allows the Base Station to send/receive a directional beam to track the user equipment position adaptively and this greatly improves the cell capacity with space selectivity.

Beamforming is realized using an array of antennas. Each antenna forming the array is known as an element of the array. The signals induced on different elements of an array are combined to form a single output of the array. This process of combining the signals from different elements is known as beam forming where signals at particular angles experience constructive interference and while others experience destructive interference.

By applying different weighting factors to one user equipment at individual transmit branches, the beam can be directed towards the user equipment with the beamforming feature. However, the radio frequency, RF, signal transmitted from transceiver to antenna will be distorted by non-ideal factors in RF chain. For example, the RF component gain will be changed with the temperature and there will be delay difference for radio frame at different RF chain. To have a “desired” direction of the beam, the relative amplitude error, phase error and time error need to be controlled within a specified range. One solution is to implement the radio calibration function using a calibration coupling network integrated with antenna. For radio unit in Base Station, this means additional calibration cables needed to send/receive the calibration signal to calibration coupling unit to calculate the timing difference, gain difference and phase difference between different RF branches.

A calibration coupling unit, CCU, is a passive separate device integrated with antenna and additional cabling between radio unit and antenna is needed. This will add the CAPEX and OPEX to the operator. The gain and phase difference of CCU itself cannot be eliminated since there is no interface between the CCU and the base Station to transport the calibration data of CCU gain and phase difference. This may add additional gain and phase uncertainty to the calibration loop.

Different types of Base Stations, e.g. indoor and outdoor Base Stations, may have different configurations. A Base Station typically comprises a Base Band Unit, BBU, and a Radio Unit, RU. The RU is connected to an antenna for transmitting and receiving signals to/from user equipments. The distance between the RU and the antenna may greatly affect the signal when travelling between the antenna and the RU in the Base Station. For en indoor Base Station, the RU and antenna can be quite far apart, for example 40 meters. 0.1 m feeder length difference between any two RF branches may introduce more than 200 degree phase error at 2 GHz. If the feeder cables are not in calibration loop, this phase error can't be calibrated.

### SUMMARY

The object is to obviate at least some of the problems outlined above. In particular, it is an object to provide a Calibration Coupling Unit, CCU, and a method therein for enabling calibration of a Base Station. These objects and others may be obtained by providing a CCU and a method in a CCU according to the independent claims attached below.

According to an aspect, a method in a CCU for enabling calibration of a Base Station is provided. The CCU comprises Antenna Interface Standards Group, AISG, interface and the CCU is connected to the Base Station by means of radio branch feeder cables carrying uplink and downlink transmissions to/from the Base Station. The Base Station comprises a Radio Unit, RU, and a Base Band Unit, BBU, and the CCU is further connectable to an antenna array comprising antenna elements. The method in the CCU comprises receiving at least one calibration signal from the RU on at least one radio branch feeder cable of the CCU; and converting the calibration signal to a receiving frequency band of the RU. The method further comprises providing the converted signal to the RU via at least one of the radio branch feeder cables, thereby enabling calibration of the Base Station.

According to an aspect, a CCU adapted for enabling calibration of a Base Station is provided. The CCU comprises an AISG interface. The Base Station comprises an RU and a BBU. The CCU is connectable to the RU via radio branch feeder cables carrying uplink and downlink transmissions to/from the Base Station. The CCU is further connectable to an antenna array comprising antenna elements. FIG. 2a illustrates the CCU comprising a receiving module adapted to receive at least one calibration signal from the RU on at least one radio branch feeder cable of the CCU. The CCU also comprises a converting module adapted to convert the calibration signal to a receiving frequency band of the RU, and a providing module adapted to provide the converted signal to the RU via at least one of the radio branch feeder cables, thereby enabling calibration of the Base Station.

The CCU and the method therein or performed by the CCU have several advantages. Since the converted signal is transmitted, outputted or provided to the Base Station on at least one of the radio branch feeder cables, no extra calibration cable or path is needed which in turn saves Operating Expenditures, OPEX, and Capital Expenditures, CAPEX of the operator. Further, coherence of a multi radio frequency radio branch feeder cables is improved for advance features such as e.g. beam forming. Another advantage is that it is possible for the Base Station to calibrate multiple radio branch feeder cables without having to upgrade the hardware of the Base Station.

### BRIEF DESCRIPTION OF DRAWINGS

Embodiments will now be described in more detail in relation to the accompanying drawings, in which:

FIG. 1a is a flowchart of an exemplifying method in a CCU for enabling calibration of a Base Station according to an embodiment.

FIG. 1b is a flowchart of an exemplifying method in a CCU for enabling calibration of a Base Station according to yet an embodiment.

FIG. 1c is a flowchart of an exemplifying method in a CCU for enabling calibration of a Base Station according to still an embodiment.

FIG. 2a is a block diagram of a CCU adapted to enable calibration of a Base Station according to an embodiment.

FIG. 2b is a block diagram of schematically illustrating a CCU being connected to a Base Station and an Antenna Array according to an embodiment.

FIG. 2c is a block diagram of schematically illustrating a CCU being connected to a Base Station and an Antenna Array according to an embodiment.

FIG. 3a is a schematic illustration of a four port Frequency Division Duplex Tower Mounted Amplifier, FDD TMA, having a CCU integrated therein for Tx calibration.

FIG. 3b is a schematic illustration of the signal flow in a four port FDD TMA for Tx calibration.

FIG. 3c is a schematic illustration of a four port FDD TMA having a CCU integrated therein for both Tx and Rx calibration.

FIG. 3d is a schematic illustration of Tx calibration signal flow in a four port FDD TMA having a CCU integrated therein for both Tx and Rx calibration.

FIG. 3e is a schematic illustration of Rx calibration signal flow in a four port FDD TMA having a CCU integrated therein for both Tx and Rx calibration.

FIG. 3f is a schematic illustration of a four port Frequency Division Duplex Tower Mounted Amplifier, FDD TMA, having a CCU integrated therein for Tx calibration with an additional calibration port.

### DETAILED DESCRIPTION

Briefly described, a Calibration Coupling Unit, CCU, and a method therein for enabling calibration of a Base Station is provided. The CCU comprises Antenna Interface Standards Group, AISG, interface and the CCU is connected to the Base Station by means of radio branch feeder cables. The enabling of calibration of the Base Station comprises providing a processed signal to the Base Station via at least one of the radio branch feeder cables, wherein the processed signal is the result of a previously received calibration signal from the Base Station.

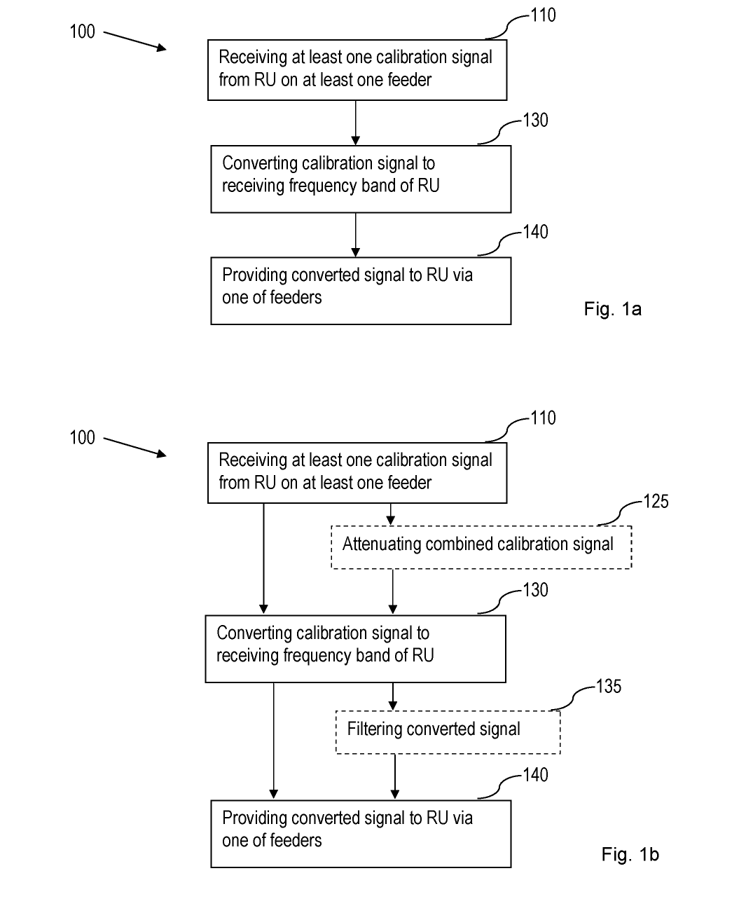

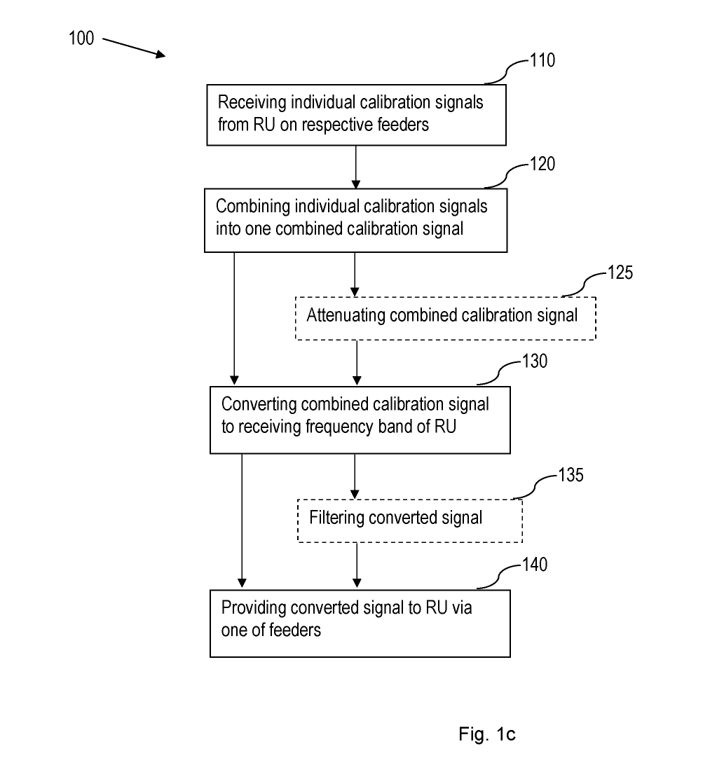

An exemplifying embodiment of such a method in a CCU will now be described with reference to the flowchart in FIG. 1a. The CCU is connected to the Base Station by means of radio branch feeder cables carrying uplink and downlink transmissions to/from the Base Station. The Base Station comprises a Radio Unit, RU, and a Base Band Unit, BBU, and the CCU is further connectable to an antenna array comprising antenna elements.

FIG. 1a illustrates the method in the CCU comprising receiving 110 at least one calibration signal from the RU on at least one radio branch feeder cable of the CCU; and converting 130 the calibration signal to a receiving frequency band of the RU. The method further comprises providing 140 the converted signal to the RU via at least one of the radio branch feeder cables, thereby enabling calibration of the Base Station.

The Base Station comprises a BBU and a RU. Both these units may be involved when generating signals to be transmitted towards e.g. a user equipment and when receiving signals from the user equipment. The Base station transmits RF signals from the RU to the antenna and receives RF signals from the antenna at the RU. CCU is needed between the RU and the antenna to calibrate the different RF transceiver paths, comprising the different radio branch feeder cables, from the RU to the antenna, or at least from the RU and the CCU. Also, the calibration of the Base Station, i.e. the calibration of the different RF transceiver paths from RU to antenna, may be separated into transmission, Tx, calibration and reception, Rx, transmission.

In order for the Base Station to be calibrated, the Base station transmits at least one calibration signal to the CCU. The calibration signal is in one example generated in the RU of the Base Station and is transmitted to the CCU on at least one radio branch feeder cable connecting the Base Station and the CCU. The CCU receives 110 the at least one calibration signal from the Base Station and converts 130 the received calibration signal to a receiving frequency band of the RU. When the CCU has converted the calibration signal to the receiving frequency band of the RU, the CCU provides 140 the converted signal to the RU via at least one of the radio branch feeder cables.

The Base Station receives the converted signal from the CCU. The converted signal provides information to the Base Station so that the Base Station is enabled to calibrate different RF transceiver paths from the RU to the CCU. The Base Station may use the converted signal at a calibration algorithm in the Base Station to calculate the gain/phase difference between the RF transmit chain or receive chain.

The method in the CCU has several advantages. Since the converted signal is transmitted, outputted or provided to the Base Station on at least one of the radio branch feeder cables, no extra calibration cable or path is needed which in turn saves Operating Expenditures, OPEX, and Capital Expenditures, CAPEX of the operator. Further, coherence of a multi radio frequency radio branch feeder cables is improved for advance features such as e.g. beam forming. Another advantage is that it is possible for the Base Station to calibrate multiple radio branch feeder cables without having to upgrade the hardware of the Base Station.

The radio branch feeder cables do not comprise a separate or dedicated cable connected to an individual calibration port of the RU for providing the converted signal to the RU, thereby providing calibration functionality to the Base Station without separate or dedicated calibration cable(s) between the CCU and the RU of the Base Station.

FIG. 1b is a flowchart of an exemplifying method in a CCU for enabling calibration of a Base Station according to further embodiments. FIG. 1b illustrates a couple of examples with optional method steps as compared to FIG. 1a.

In an example, the CCU enables the Base Station to be calibrated with regards to Rx receiving. In this example, which is illustrated in FIG. 1b, only one calibration signal is received 110 from the RU on one radio branch feeder cable of the CCU. The method in this example comprises converting 130 the calibration signal to a receiving frequency band of the RU. The method further comprises providing 140 the converted signal to the RU via at least one of the radio branch feeder cables, thereby enabling calibration of the Base Station with regards to Rx receiving.

It shall be pointed out that in this example, the same numerical “110” is used in FIG. 1a. This is because at least one “covers” just one, i.e. one calibration signal from the RU on one radio branch feeder cable of the CCU is an example of at least one calibration signal from the RU on at least one radio branch feeder cable of the CCU.

The reason why only one calibration signal is needed for calibration of the Base Station for Rx calibration is that a calibration algorithm in the Base Station can cancel out transmit channel response impact with same injected calibration signal to different RX transmission paths or radio branch feeder cables.

FIG. 1c illustrates an example of the method which comprises receiving 110 individual calibration signals from the RU per respective radio branch feeder cable of the CCU, and combining 120 the individual calibration signals into one combined calibration signal. The method further comprises converting 130 the combined calibration signal to a receiving frequency band of the RU: and providing 140 the converted signal to the RU via at least one of the radio branch feeder cables, thereby enabling transmission, Tx, calibration of the Base Station.

In this example, Tx calibration of the Base Station is enabled. When the Base Station transmits signals to a user equipment, the Base Station may make use of all radio branch feeder cables between the Base Station and the CCU. This might be necessary for performing beam forming. In such a scenario, the Base Station transmits a plurality of individual calibration signals from the RU of the Base Station to the CCU, wherein each individual calibration signal is transmitted on a respective radio branch feeder cable. It shall be pointed out that, in one example, each individual calibration signal is unique with regards to the other individual calibration signals which are sent to the CCU on respective radio branch feeder cables between the Base Station and the CCU. In another example, some or all calibration signals may be the same, but then they are transmitted from the Base Station at different time intervals in order to separate the calibration signals when they are received by, or returned to, the Base Station. In yet an example, the different calibration signals may be Time Division Multiplexing, TDM, Frequency Division Multiplexing, FDM or Code Division Multiplexing, CDM may be applied to the different calibration signals.

The CCU receives 110 the plurality of calibration signals from the RU per respective radio branch feeder cable of the CCU. It shall be noted that the same numerical “110” is used in FIG. 1a and FIG. 1b. This is because at least one “covers” several, i.e. individual calibration signals from the RU per respective radio branch feeder cable of the CCU is an example of at least one calibration signal from the RU on at least one radio branch feeder cable of the CCU.

Once the CCU has received the individual calibration signals from the RU per respective radio branch feeder cable of the CCU, the CCU combines 120 the individual calibration signals into one combined calibration signal. In this manner, one single calibration signal is obtained. The combined single calibration signal comprises information pertaining to how a transmitted signal (to e.g. a user equipment) is affected by the respective radio branch feeder cables connecting the CCU and the Base Station, when “travelling” between the CCU and the Base Station.

After the individual calibration signals have been combined into one combined calibration signal, the CCU converts 130 the combined calibration signal to a receiving frequency band of the RU. Thereafter, the CCU providing 140 the converted signal to the RU via at least one of the radio branch feeder cables.

In this manner, the CCU enables the Base Station to be calibrated with regards to Tx transmission, also referred to as Tx calibration.

According to an embodiment, the method further comprises attenuating 125 the at least one calibration signal or the combined calibration signal before converting it to the receiving frequency band.

This is illustrated in both FIG. 1a and FIG. 1b by a dotted box. The box being dotted illustrates that it is optional. The attenuation may thus be performed for both Rx calibration, i.e. when only one calibration signal is received from the Base Station; and for Tx calibration, i.e. when a plurality of individual calibration signals are received on respective radio branch feeder cables from the Base Station.

The received calibration signal(s) may be have a power being relatively high. Especially in the case of the combined calibration signal wherein several individual calibration signals have been combined, or added, in the CCU, the calibration signal may need to be attenuated before being provided to the Base Station. And this attenuation will also give possibility for CCU to work with different power class RU, and different radio branch feeder cable length.

According to yet an embodiment, the method further comprises filtering 135 the converted signal to eliminate unwanted introduced spurious emission from the converter, or conversion step, the filtering taking place after converting the combined calibration signal to a receiving frequency band and before outputting the converted signal on at least one of the N RU-port towards the RU.

When the CCU converts the calibration signal or the combined calibration signal to a receiving frequency band of the RU, the conversion step may introduce spurious emission from hardware components actually performing the conversion. The hardware components may be referred to as “the converter”. This will be explained in more detail below. There may also be other unwanted products introduced to the calibration signal which may be filtered out by the filtering step 135. The filtering 135 is illustrated in both FIGS. 1b and 1c by a dotted box. The box being dotted illustrates that it is optional.

According to still an embodiment, the CCU is adapted to operate in conjunction with a second CCU comprised in the antenna.

The CCU should be located as close to the antenna array as possible. This is because the cables connecting the CCU and the antenna array will distort or influence the signals in both uplink and downlink as the signals travel between the antenna array and the CCU. The longer the cables, the larger distortion or influence on the signals.

Since the Base Station may be calibrated for any possible influence from the radio branch feeder cables up to the CCU, the cables connecting the CCU and the antenna array should be as short as possible. In order to calibrate the Base Station also with regards to the cables connecting the CCU and the antenna array, a second CCU may be implemented in the antenna, wherein the second CCU cooperates with the CCU described above, also referred to as the first CCU.

Alternatively, the first CCU is implemented in the antenna array.

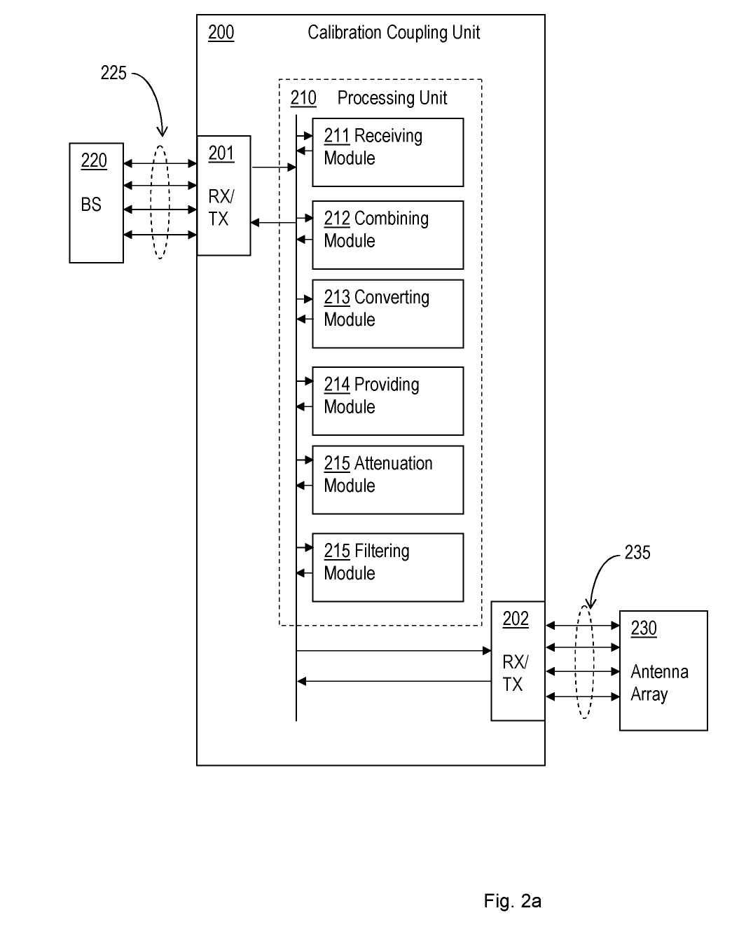

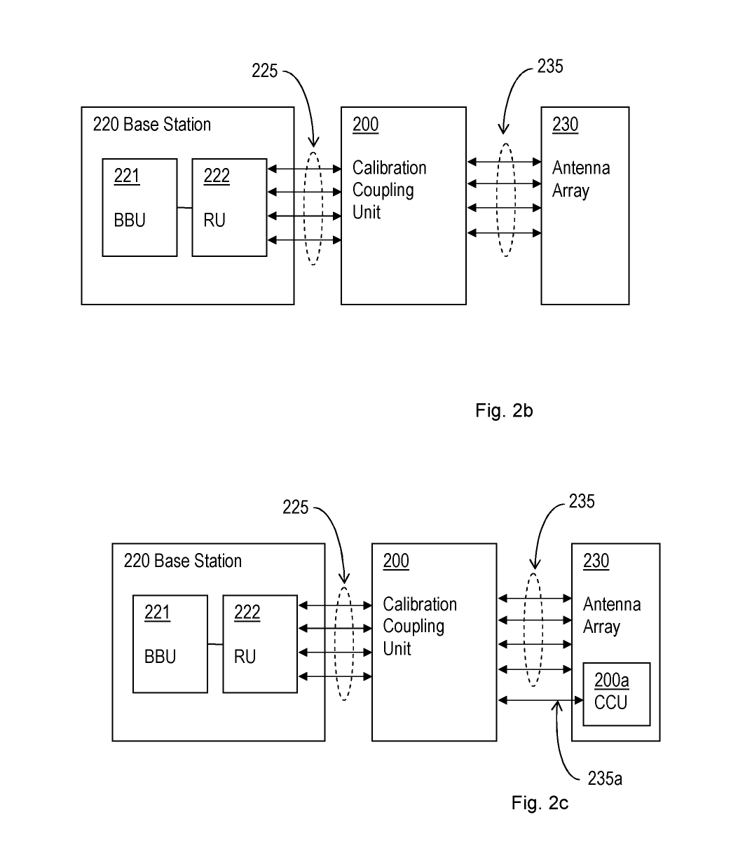

Embodiments herein also relate to a CCU for enabling calibration of a Base Station. Such embodiments will now be described with reference to FIGS. 2a and 2b.

The CCU will be described in brief in order to avoid unnecessary repetition.

FIG. 2a is a block diagram of a CCU 200 adapted to enable calibration of a Base Station 220 according to an embodiment. The CCU 200 comprises an AISG interface. The Base Station 220 comprises an RU and a BBU. The CCU is connectable to the RU via radio branch feeder cables 225 carrying uplink and downlink transmissions to/from the Base Station. The CCU 200 is further connectable to an antenna array 230 comprising antenna elements.

FIG. 2a illustrates the CCU 200 comprising a receiving module 211 adapted to receive at least one calibration signal from the RU on at least one radio branch feeder cable of the CCU 200. The CCU 200 also comprises a converting module 213 adapted to convert the calibration signal to a receiving frequency band of the RU, and a providing module 214 adapted to provide the converted signal to the RU via at least one of the radio branch feeder cables 225, thereby enabling calibration of the Base Station 220.

It should be noted that FIG. 2a merely illustrates various functional units and modules in the CCU in a logical sense. The functions in practice may be implemented using any suitable software and hardware means/circuits etc. Thus, the embodiments are generally not limited to the shown structures of the CCU and the functional units and modules. Hence, the exemplary embodiments may be realised in many ways.

The CCU has the same advantages as the method in, or performed by, the CCU. Since the converted signal is transmitted, outputted or provided to the Base Station on at least one of the radio branch feeder cables, no extra calibration cable or path is needed which in turn saves Operating Expenditures, OPEX, and Capital Expenditures, CAPEX of the operator. Further, coherence of a multi radio frequency radio branch feeder cables is improved for advance features such as e.g. beam forming. Another advantage is that it is possible for the Base Station to calibrate multiple radio branch feeder cables without having to upgrade the hardware of the Base Station.

The radio branch feeder cables 225 do not comprise a separate or dedicated cable connected to an individual calibration port of the RU for providing the converted signal to the RU, thereby providing calibration functionality to the Base Station 220 without separate or dedicated calibration cable(s) between the CCU 200 and the RU of the Base Station 220.

According to an embodiment, the receiving module 211 is further adapted to receive individual calibration signals from the RU per respective radio branch feeder cable of the CCU. The CCU further comprises a combining module 212 adapted to combine the individual calibration signals into one combined calibration signal, wherein the converting module 213 is adapted to convert the combined calibration signal to a receiving frequency band of the RU. The providing module 214 is adapted to provide the converted signal to the RU via at least one of the radio branch feeder cables 225, thereby enabling transmission, Tx, calibration of the Base Station 220.

According to an embodiment, the CCU 200 further comprises an attenuation module 215 adapted to attenuate the at least one calibration signal or the combined calibration signal before the converting module 213 converts it to the receiving frequency band.

According to still an embodiment, the CCU 200 further comprises a filtering module 216 adapted to filter the converted signal to eliminate unwanted introduced spurious emission from the converter, the filtering taking place after converting the combined calibration signal to a receiving frequency band and before the providing module 214 outputs the converted signal on at least one of the radio branch feeder cables towards the RU.

According to still an embodiment, the CCU 200 is further adapted to operate in conjunction with a second CCU in the antenna 230.

Embodiments herein also relate to a Tower Mounted Amplifier, TMA, comprising a CCU as described above. The TMA typically comprises an AISG interface.

Alternatively, the CCU is incorporated into a diplexer in an example.

FIG. 2b is a block diagram of schematically illustrating a CCU being connected to a Base Station and an Antenna Array.

FIG. 2b illustrates a Base Station 220 comprising a BBU 221 and a RU 222. The RU 222 of the Base Station 220 is connected to a CCU 200 by means of radio branch feeder cables 225. The CCU 200 in turn is connected to an antenna array 230 my means of cables 235.

FIG. 2c is a block diagram of schematically illustrating a CCU being connected to a Base Station and an Antenna Array according to an embodiment. In this embodiment, a second CCU 200a is integrated into the antenna 230 and cooperates with the first CCU 200. This enables calibration also with regards to the cables 235 connecting the first CCU and the antenna 230. In one example, an additional calibration cable 235a is needed in order for the second CCU 200a to communicate with the first CCU 200.

In an example, the CCU is integrated in the TMA. The TMA is typically arranged close to the antenna and by integrating the CCU the radio branch feeder cables are part of the calibration loop. Such a solution may compensate for radio branch feeder cable loss and it may also improve sensitivity in uplink.

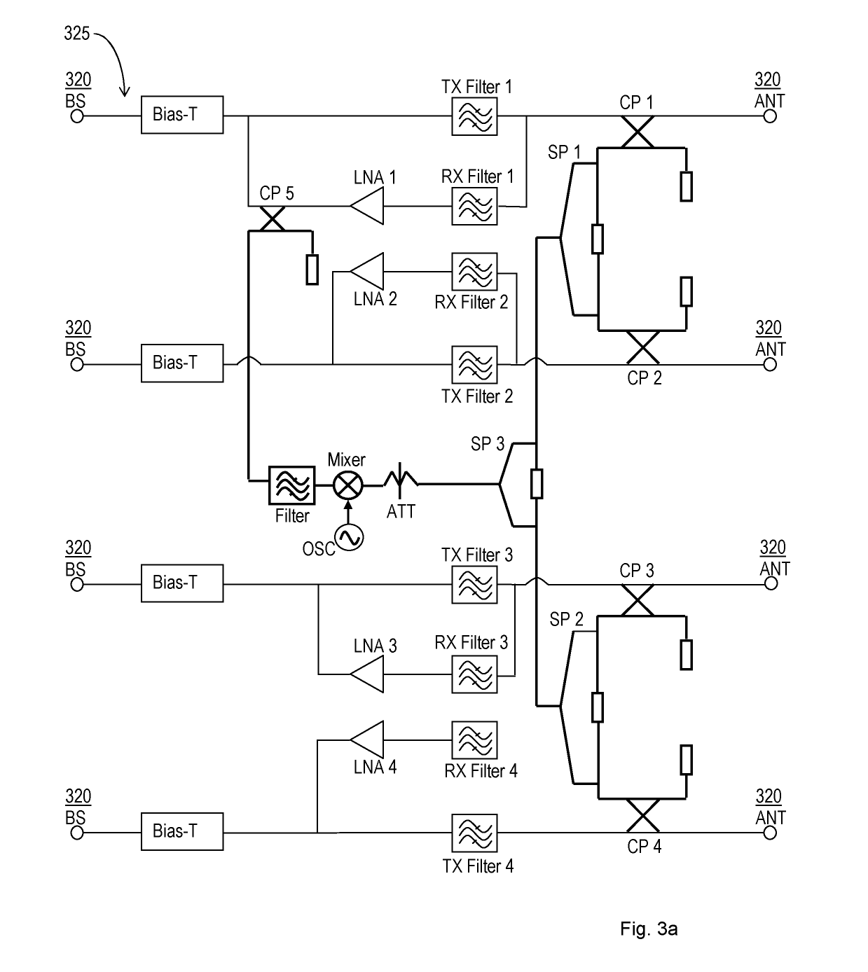

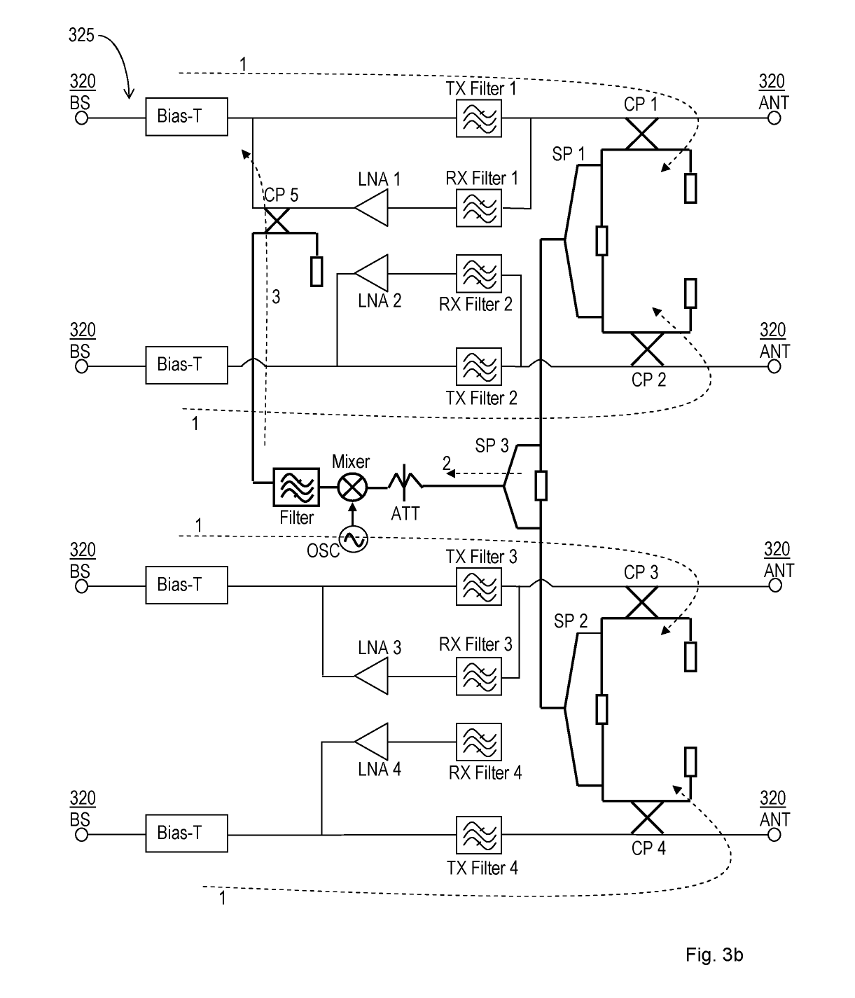

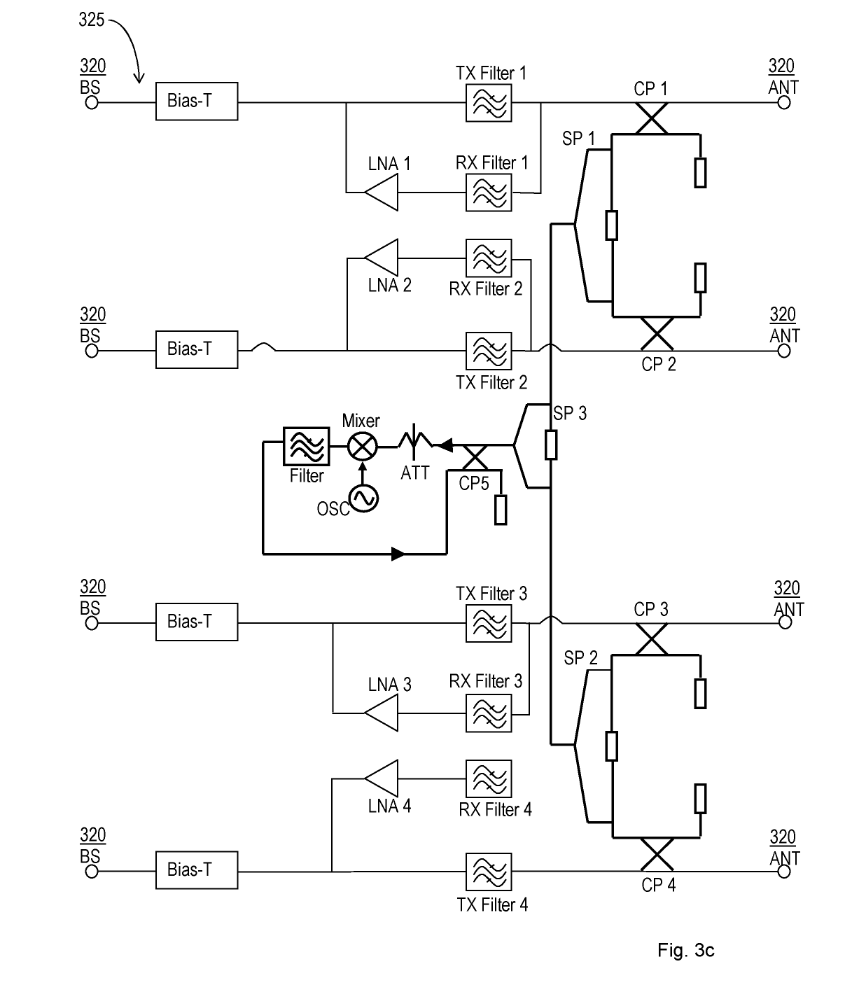

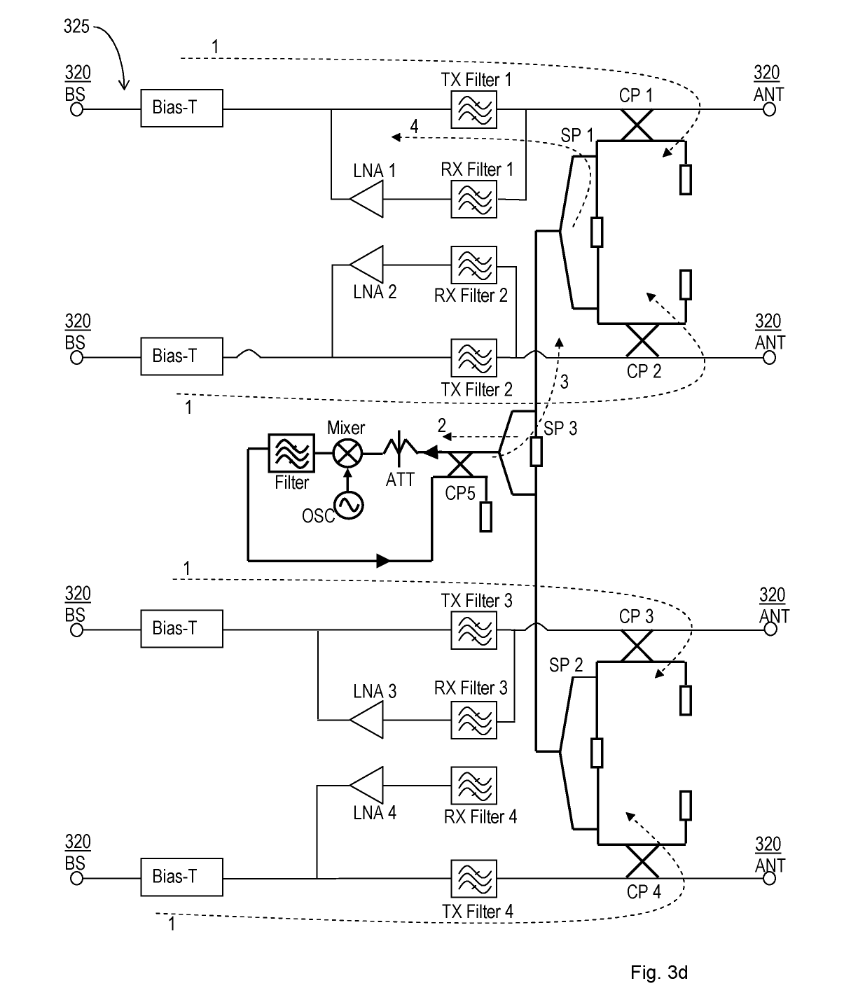

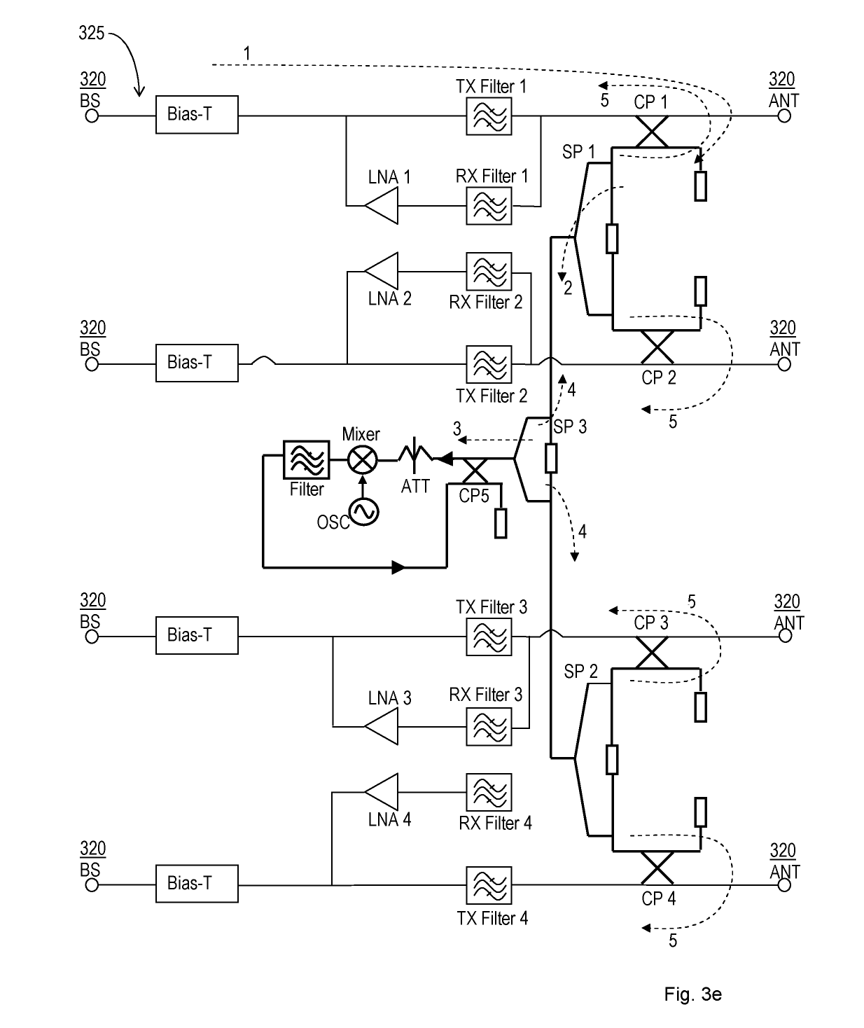

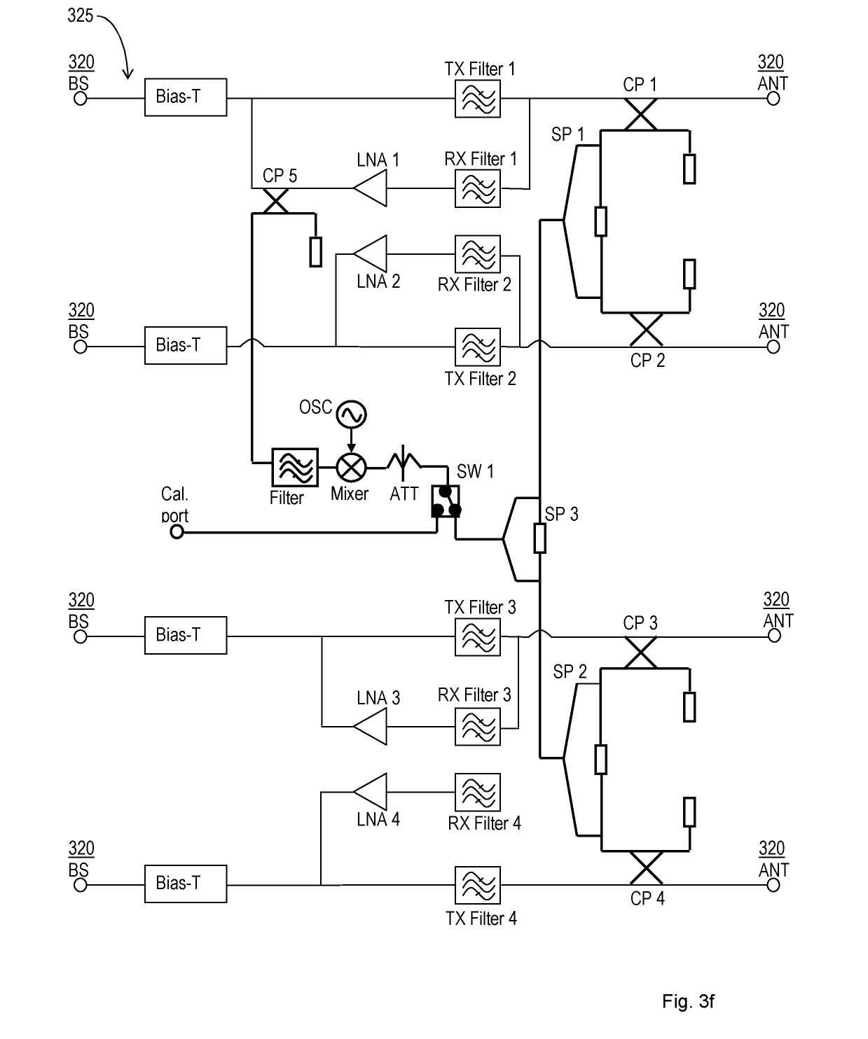

FIGS. 3a-3f illustrate different examples of a CCU integrated with or into the TMA. In the figures, the bold lines and boxes illustrate the CCU part and the non-bold lines and boxes illustrate the TMA part. By integrating the CCU into the TMA, the calibration is done between the TMA and the Base Station. Consequently, the radio branch feeder cables are in the calibration loop, and the relative gain/phase error between different transmission branches caused by the radio branch feeder cables may be eliminated and/or compensated for.

FIGS. 3a-3f illustrate the base station 320 being connected to the TMA by means of radio branch feeder cables 325. FIGS. 3a-3e further illustrate the TMA being connected to the antenna 320. The Base station will send at least one calibration signal, as described above, to the TMA/CCU.

The CCU itself, or the TMA having an integrated CCU may be calibrated separately at e.g. production and the data obtained by the calibration may be stored at e.g. a TMA database. This stored calibration data for the CCU/TMA may be transmitted to the Base Station using the AISG interface and used by the Base Station to improve the accuracy of the calibration of the Base Station.

FIGS. 3a-3f illustrate a four port FDD TMA having an integrated CCU. It shall be noted that the figures illustrate an example, and the FDD TMA may have more or less than four ports.

FIG. 3a is a schematic illustration of a four port FDD TMA having a CCU integrated therein for Tx calibration only.

FIG. 3a illustrates the FDD TMA having four directional couplers. These are denoted CP1, CP2, CP3 and CP4. The four couplers are arranged to couple four Tx calibration signals, Tx1-Tx4, to a calibration path. FIG. 3a also illustrates the FDD TMA comprising three combiners denoted SP1, SP2 and SP3. SP1 combines the coupled Tx calibration signals Tx1 and Tx2. SP2 combines the coupled Tx calibration signals Tx3 and Tx4. Then SP3 combines the combined Tx1 and Tx2 with Tx3 and Tx4 into one combined calibration signal.

After S3 has combined the Tx calibration signals into one combined calibration signal, the combined calibration signal is attenuated by means of an attenuator which is denoted ATT in FIG. 3a. FIG. 3a also illustrates the TMA having a mixer connected to an oscillator denoted OSC or a frequency synthesizer, which together constitute a converter. The converter is arranged to convert the attenuated combined calibration signal to the Rx frequency band of the RU. To the left of the mixer in FIG. 3a, a filter is illustrated. The filter has a pass band which is the same as the Rx frequency band of the RU. The filter is arranged to filter out unwanted introduced spurious emission from the converter including leakage of the calibration signals Tx1-Tx4.

FIG. 3a also illustrates the TMA comprising a directional coupler, denoted CP5, which is arranged to provide the filtered signal to the RU of the Base Station.

It shall be noted that an additional switch (not shown) may be arranged between the SP3 and the mixer/converter in order to prevent disturbance from transmission branch to reception branch at normal operation.

FIG. 3b is a schematic illustration of the signal flow in the four port FDD TMA for Tx calibration.

FIG. 3b illustrates the Base Station transmitting four individual Tx calibration signals. These four individual signals will travel or flow through the TMA as illustrated by the four dotted arrows having reference number 1. They travel from the four individual Bias-T through four individual transmission filters denoted TX Filter 1, TX Filter 2, TX Filter 3 and TX Filter 4.Thereafter, the four couplers CP1-CP4 directs at least a portion of each individual calibration signal Tx1-Tx4 towards the two combiners SP1 and SP2. After the combiners the combined TX calibration signals travel to, and through, the third combiner SP3. This is illustrated in FIG. 3b by the dotted arrow having reference number 2.

Thereafter, the one combined Tx calibration signals travels through the converter, i.e. the mixer and oscillator arrangement, and the filter. From the filter, the calibration signal travels through coupler CP5 and to the BS 320 by means of the top (in the figure) radio branch feeder cable. This is illustrated by the dotted arrow having reference number 3.

FIG. 3c is a schematic illustration of a four port FDD TMA having a CCU integrated therein for both Tx and Rx calibration.

This four port FDD TMA for Tx and Rx calibration differs from the four port FDD TMA for only Tx calibration in the way the combined, attenuated and filtered signal is coupled in the FDD TMA. For the FDD TMA only for Tx calibration, the combined, attenuated and filtered signal is coupled to the CP5 coupler in order for the signal to be provided to the RU/Base Station by the top radio branch feeder cable, wherein the coupler CP5 is arranged at the top radio branch feeder cable. It shall be pointed out that any of the four radio branch feeder cables could be used, and having the coupler CP arranged at the top one as in the figure is merely an example.

For the FDD TMA for both Tx and Rx calibration, the coupler CP5 is instead arranged at the combiner SP3. Below, the signal flow for Tx calibration and for Rx calibration is illustrated for this example of this four port FDD TMA for Tx and Rx calibration.

FIG. 3d is a schematic illustration of Tx calibration signal flow in the four port FDD TMA having a CCU integrated therein for both Tx and Rx calibration.

FIG. 3d illustrates the Base Station transmitting four individual Tx calibration signals. These four individual signals will travel or flow through the TMA as illustrated by the four dotted arrows having reference number 1. They travel from the four individual Bias-T through four individual transmission filters denoted TX Filter 1, TX Filter 2, TX Filter 3 and TX Filter 4.Thereafter, the four couplers CP1-CP4 directs at least a portion of each individual calibration signal Tx1-Tx4 towards the two combiners SP1 and SP2. After the combiners the combined TX calibration signals travel to, and through, the third combiner SP3. This is illustrated in FIG. 3b by the dotted arrow having reference number 2.

Thereafter, the one combined Tx calibration signals travels through the converter, i.e. the mixer and oscillator arrangement, and the filter. From the filter, the combined, converted and attenuated calibration signal is coupled back to the third combiner SP3. The signal travels towards the first combiner, SP1 and this is illustrated by the dotted arrow with reference number 3 in FIG. 3d. The signal passes or travels through the first combiner SP1 and is provided to the RU/Base Station on the top radio branch feeder cable. This is illustrated by the dotted arrow with reference number 4. It shall be pointed out that the signal will travel through SP1 to first and second feeder cable, and also travel through SP2 to third and forth feeder cable. Basically the signal will go to all feeder cables, and any one of RX branch can be used for TX calibration. Hence, for simplicity, only the return path by the top radio branch feeder cable is illustrated.

FIG. 3e is a schematic illustration of Rx calibration signal flow in a four port FDD TMA having a CCU integrated therein for both Tx and Rx calibration.

FIG. 3e illustrates, that for Rx calibration, one calibration signal is transmitted from the Base Station and received at the FDD TMA. The calibration signal travels through the Bias-T, the first transmission filter, denoted TX Filter 1 and to the first coupler CP1. This is illustrated by the dotted arrow with reference number 1. The calibration signal then travels through the first combiner SP1, which is illustrated by the dotted arrow with reference number 2.

The calibration signal thereafter travels through the third combiner SP3, illustrated by the dotted arrow with reference number 3, through the attenuator, the converter and the mixer and then to the coupler CP5. From CP5, the calibration signal, which is now attenuated, converted to the Rx frequency band of the RU of the Base Station and filtered, travels back through the third combiner SP3. The signal it there divided or splitted to that a portion of it travels towards the first combiner SP1 and a second portion of it travels towards the second combiner SP2. This is illustrated by the dotted arrow with reference number 4.

As the two portions of the signal reach the first and the second combiner SP1 and SP2 respectively, the respective portion is again divided or splitted so that one portion travels through the first combiner CP1 towards the RU/Base Station, one portion travels through the second combiner CP2 towards the RU/Base Station, one portion travels through the third combiner CP3 towards the RU/Base Station and one portion travels through the fourth combiner CP4 towards the RU/Base Station. This is illustrated by the dotted arrows with reference number 5.

It is assumed that either there is unused Rx frequency at Base Station that can be used to configure as the calibration carrier, or the calibration carrier is sent on the Rx frequency of an existing carrier. The Base Station may set the calibration carrier using the AISG interface to TMA.

If an existing carrier is used, scheduling of uplink data may be disabled while calibration is being done to avoid that uplink signals from user equipments disturb the calibration signal. Another example is to ensure that the quality of the calibration signal is sufficient even with interfering signals. This may be done by increasing the strength of the calibration signal and by using a longer calibration signal to get higher processing gain.

The coupling network, i.e. the CCU part, at TMA can be calibrated at production. The relative amplitude and phase error can be stored at a TMA database and later transported to the Base Station by using AISG interface.

FIG. 3f is a schematic illustration of a four port Frequency Division Duplex Tower Mounted Amplifier, FDD TMA, having a CCU integrated therein for Tx calibration with an additional calibration port.

The TMA having a CCU incorporated therein is also referred to as enhanced TMA. The enhanced TMA may be used together with radio unit with/without calibration port and antenna with/without the calibration network integrated. To adapt to the different used scenario, the enhanced TMA may be needed with one additional calibration port. Such an example is illustrated in FIG. 3f. A switch denoted SW1 controls the radio frequency, RF, signal input to the mixer/converter.

In FIG. 2a, the CCU is also illustrated comprising a first transmitting/receiving unit 201 and a second transmitting/receiving unit 202. Through these two units, the CCU is adapted to communicate with the RU of the base Station 220 and the Antenna Array 230. The transmitting/receiving units 201 and 202 may comprise more than one transmitting arrangement and more than one receiving arrangement. Further, the CCU 200 is illustrated comprising a processing unit 210 which in turns comprises the different modules 211-215. It shall be pointed out that this is merely an illustrative example and the CCU may comprise more, less or other units or modules which execute the functions of the CCU in the same manner as the units and modules illustrated in FIG. 2a.

It should be noted that FIG. 2a merely illustrates various functional units and/or modules in the CCU in a logical sense. The functions in practice may be implemented using any suitable software and hardware means/circuits etc. Thus, the embodiments are generally not limited to the shown structures of the CCU and the functional units and/or modules. Hence, the previously described exemplary embodiments may be realised in many ways. For example, one embodiment includes a computer-readable medium having instructions stored thereon that are executable by the processing unit for executing the method steps in the CCU. The instructions executable by the computing system and stored on the computer-readable medium perform the method steps of the CCU as set forth in the claims.

FIG. 2a schematically shows an embodiment of a CCU 200. Comprised in the CCU 200 are here a processing unit 210, e.g. with a DSP (Digital Signal Processor). The processing unit 210 may be a single unit or a plurality of units to perform different actions of procedures described herein. The CCU 200 may also comprise an input unit for receiving signals from other entities, and an output unit for providing signal(s) to other entities. The input unit and the output unit may be arranged as an integrated entity or as illustrated in the example of FIG. 2a, as one or more interfaces 201 and 202.

Furthermore, the CCU 200 comprises at least one computer program product in the form of a non-volatile memory, e.g. an EEPROM (Electrically Erasable Programmable Read-Only Memory), a flash memory and a hard drive. The computer program product comprises a computer program, which comprises code means, which when executed in the processing unit 210 in the CCU 200 causes the CCU 200 to perform the actions e.g. of the procedure described earlier in conjunction with FIGS. 1a-1c.

The computer program may be configured as a computer program code structured in computer program modules. Hence, in an exemplifying embodiment, the code means in the computer program of the CCU 200 comprises a receiving module for receiving at least one calibration signal from the RU on at least one radio branch feeder cable of the CCU. The computer program further comprises a converting module for converting the calibration signal to a receiving frequency band of the RU, and a providing module for providing the converted signal to the RU via at least one of the radio branch feeder cables, thereby enabling calibration of the Base Station.

The computer program modules could essentially perform the actions of the flow illustrated in FIGS. 1a-1c, to emulate the CCU 200.

Although the code means in the embodiment disclosed above in conjunction with FIG. 2a are implemented as computer program modules which when executed in the processing unit causes the CCU 200 to perform the actions described above in the conjunction with figures mentioned above, at least one of the code means may in alternative embodiments be implemented at least partly as hardware circuits.

The processor may be a single CPU (Central processing unit), but could also comprise two or more processing units. For example, the processor may include general purpose microprocessors; instruction set processors and/or related chips sets and/or special purpose microprocessors such as ASICs (Application Specific Integrated Circuit). The processor may also comprise board memory for caching purposes. The computer program may be carried by a computer program product connected to the processor. The computer program product may comprise a computer readable medium on which the computer program is stored. For example, the computer program product may be a flash memory, a RAM (Random-access memory) ROM (Read-Only Memory) or an EEPROM, and the computer program modules described above could in alternative embodiments be distributed on different computer program products in the form of memories within the CCU 200.

It is to be understood that the choice of interacting units, as well as the naming of the units within this disclosure are only for exemplifying purpose, and nodes suitable to execute any of the methods described above may be configured in a plurality of alternative ways in order to be able to execute the suggested procedure actions.

It should also be noted that the units described in this disclosure are to be regarded as logical entities and not with necessity as separate physical entities.

Comparing FIG. 2a with FIGS. 3a-3f, the first transmitting/receiving unit 201 and the receiving module in FIG. 2a may correspond to the four Bias-T units in FIGS. 3a-3f. The combining module 212 of FIG. 2a may correspond to the four couplers CP1, CP2, CP3 and CP4 together with the three combiners SP1, SP2 and SP3 in FIGS. 3a-3f. Further, the converting module 213 in FIG. 2a may correspond to the mixer and oscillator in FIGS. 3a to 3f. The attenuation module 215 in FIG. 2a may correspond to the attenuator denoted ATT in FIGS. 3a-3f. Further, the filtering module 215 of FIG. 2a may correspond to the filter in FIGS. 3a-3f which is arranged next to the mixer and oscillator. The providing module 214 in FIG. 2a may correspond to e.g. the coupler CP5 in FIGS. 3a-3e, or the switch SW1 in FIG. 3f.

While the embodiments have been described in terms of several embodiments, it is contemplated that alternatives, modifications, permutations and equivalents thereof will become apparent upon reading of the specifications and study of the drawings. It is therefore intended that the following appended claims include such alternatives, modifications, permutations and equivalents as fall within the scope of the embodiments and defined by the pending claims.

1. A method in a Calibration Coupling Unit, CCU, comprising Antenna Interface Standards Group, AISG, interface for enabling calibration of a Base Station comprising a Radio Unit, RU, and a Base Band Unit, BBU, the CCU being connected to the RU via radio branch feeder cables carrying uplink and downlink transmissions to/from the Base Station, the CCU further being connectable to an antenna array comprising antenna elements, the method comprising:
receiving at least one calibration signal from the RU on at least one radio branch feeder cable of the CCU,
converting the calibration signal to a receiving frequency band of the RU, and
providing the converted signal to the RU via at least one of the radio branch feeder cables, thereby enabling calibration of the Base Station.

2. A method according to claim 1, wherein the radio branch feeder cables do not comprise a separate or dedicated cable connected to an individual calibration port of the RU for providing the converted signal to the RU, thereby providing calibration functionality to the Base Station without separate or dedicated calibration cable(s) between the CCU and the RU of the Base Station.

3. A method according to claim 1, comprising
receiving individual calibration signals from the RU per respective radio branch feeder cable of the CCU,
combining the individual calibration signals into one combined calibration signal,
converting the combined calibration signal to a receiving frequency band of the RU, and
providing the converted signal to the RU via at least one of the radio branch feeder cables, thereby enabling transmission, Tx, calibration of the Base Station.

4. A method according to claim 3, further comprising attenuating the at least one calibration signal or the combined calibration signal before converting it to the receiving frequency band.

5. A method according to claim 4, further comprising filtering the converted signal to eliminate unwanted introduced spurious emission from the converter, the filtering taking place after converting the combined calibration signal to a receiving frequency band and before outputting the converted signal on at least one of the radio branch feeder cables towards the RU.

6. A method according to claim 1, wherein the CCU is adapted to operate in conjunction with a second CCU comprised in the antenna.

7. A Calibration Coupling Unit, CCU, comprising Antenna Interface Standards Group, AISG, interface for enabling calibration of a Base Station comprising a Radio Unit, RU, and a Base Band Unit, BBU, the CCU being connectable to the RU via radio branch feeder cables carrying uplink and downlink transmissions to/from the Base Station, the CCU further being connectable to an antenna array comprising antenna elements, the CCU comprising:
a receiving module adapted to receive at least one calibration signal from the RU on at least one radio branch feeder cable of the CCU,
a converting module adapted to convert the calibration signal to a receiving frequency band of the RU, and
a providing module adapted to provide the converted signal to the RU via at least one of the radio branch feeder cables, thereby enabling calibration of the Base Station.

8. A CCU according to claim 7, wherein the radio branch feeder cables do not comprise a separate or dedicated cable connected to an individual calibration port of the RU for providing the converted signal to the RU, thereby providing calibration functionality to the Base Station without separate or dedicated calibration cable(s) between the CCU and the RU of the Base Station.

9. A CCU according to claim 7, wherein the receiving module is further adapted to receive individual calibration signals from the RU per respective radio branch feeder cable of the CCU, the CCU further comprising a combining module adapted to combine the individual calibration signals into one combined calibration signal, wherein the converting module is adapted to convert the combined calibration signal to a receiving frequency band of the RU, wherein the providing module is adapted to provide the converted signal to the RU via at least one of the radio branch feeder cables, thereby enabling transmission, Tx, calibration of the Base Station.

10. A CCU according to claim 9, further comprising an attenuation module adapted to attenuate the at least one calibration signal or the combined calibration signal before the converting module converts it to the receiving frequency band.

11. A CCU according to claim 10, further comprising a filtering module adapted to filter the converted signal to eliminate unwanted introduced spurious emission from the converter, the filtering taking place after converting the combined calibration signal to a receiving frequency band and before the providing module outputs the converted signal on at least one of the radio branch feeder cables towards the RU.

12. A CCU according to claim 7, further being adapted to operate in conjunction with a second CCU in the antenna.

13. (canceled)
